(19) United States
(12) Patent Application Publication
(10) Pub. No.: US 2004/0088320 A1
(43) Pub. Date: May 6, 2004

(54) Methods and apparatus for storing hierarchical documents in a relational database

(76) Inventor: Russell Perry, Bristol (GB)

Correspondence Address: HEWLETT-PACKARD COMPANY, Intellectual Property Administration, P.O. Box 272400, Fort Collinsk, CO, 80527-2400, US

(21) Appl. No.: 10/687,301

(22) Filed: Oct. 15, 2003

(30) Foreign Application Priority Data
Oct. 30, 2002 (GB) 0225301.1

(51) Int. Cl. G06F 17/00

(52) U.S. Cl. 707/103 R

(57) ABSTRACT

A method of storing a hierarchical document in a relational database comprises parsing a hierarchical document, associating a unique identifier with respective parsed nodes of the document which includes information about the hierarchical position of the node in the document, and storing the node with its identifier in a table of a relational database.

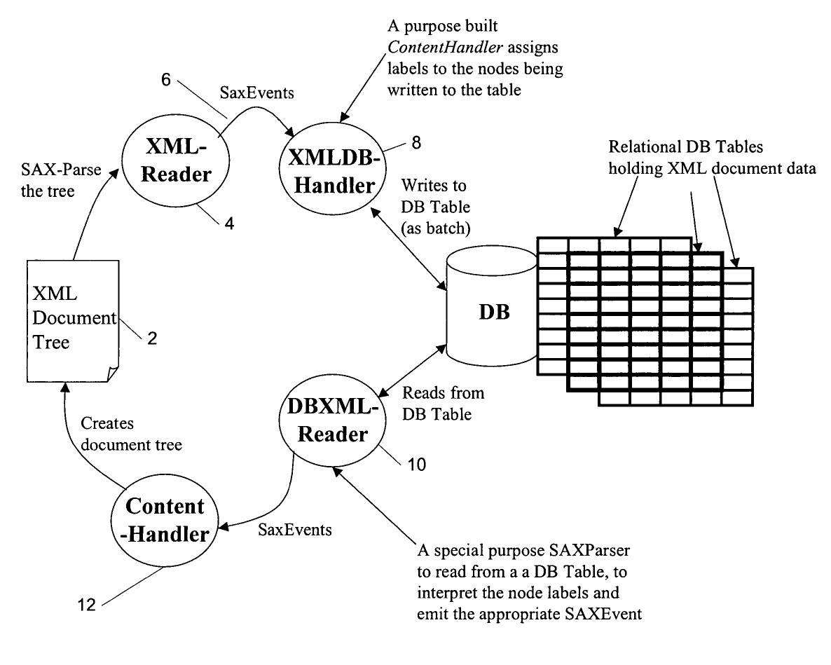

A relational database comprising a table having an node field for storing an node of a hierarchical document, and an identifier field for storing an identifier associated with each respective node stored in the node field is also described, as is a method of writing a hierarchical document comprising reading data from a relational database which is representative of nodes of a hierarchical document, generating predetermined software events for respective read nodes, and passing the software events to a content handler which is arranged to translate each software event into a written node of the hierarchical document.

This invention relates to the storage and retrieval of hierarchical documents such as extensible mark up language (XML) documents, in a relational database.

XML is rapidly gaining popularity as a means of classifying, exchanging and storing information and of representing it in a standardised syntactical form. The XML syntax specification is available from the site http://www.w3.org/TR/REC-xml in a document entitled “Extensible Markup Language (XML) 1.0 Second Edition. An XML document is essentially a tree structure, which conforms to a set of syntactical (or structural) rules. A parser can determine whether a document conforms to these rules. The XML document may be manifested in many ways, For example it could be a text document stored as a file on a hard disk or it could be an in memory representation stored as bytes for processing by a computer program. An attraction of XML is its extensibility, which simply means that it is possible to specify additional syntactic rules to which certain types of XML document must conform. These additional rules are predetermined syntactical constructions, which assign meaning to certain of the textual constructs. Thus, in common with other structured languages such as computer programming languages like CC++ or Pascal, the documents can be parsed to isolate the elements forming the document and then processed as desired.

The de facto event based parser for XML is the so-called SAX parser (SAX is derived from the term simple API (Application Programming Interface) for XML. Details about this parser can be found at http://www.saxproject.org. An API is a set of one or more interfaces that define how an external SW component should use or interact with another piece of software. Developers will frequently agree on interfaces and then write the code to actually provide the functionality defined in the interface. Two interfaces defined at http://www.saxproject.org are highlighted here for the purposes of describing this invention. These are the XMLReader Interface and the ContentHandler Interface. XMLReader provides an interface for reading an XML document using callbacks; the XMLReader is also called a SAXParser. The ContentHandler receives notification of the logical content of the Document. A SAX parser is able to parse an XML document by performing a depth first traversal (sometimes called a dynastic ordered traversal) generating events as it finds distinct nodes. Note that the XML document being parsed need not be held in memory in a tree structure. For example the SAX Parser may simply parse the document directly from file. The events contain information about the node. Typically, the SAX events are passed to another software component (implementing the ContentHandler interface) to perform whatever action is required on the document. The class implementing the ContentHandler interface can perform operations based on the events or may be used to build an in-memory representation of the document.

Although these aspects of XML usage are now reasonably well developed, a persistent need in the XML community has been the storage of an XML document and ideally structured querying of the document, using a relational database. This problem so far has not been conveniently solved.

Relational databases are not ideally suited to the storage of hierarchical documents. However, with the adoption of XML technology, it is desirable to be able to read and write documents to a relational database since this, for example, allows exploitation of an existing base of database installations with proven track records for reliability and also allows the features of a relational database to be exploited. For example relational databases are mature and are known to scale well.

One approach to this problem is that set out in “A performance evaluation of alternative mapping schemes for storing XML data in a relational database”, Daniela Florescu and Donal Kossmann, Unite de recherche INRIA Rocquencourt, May 1999 The paper describes several schemes for storing XML documents in a relational database. Their preferred solution requires the use of separate tables for every attribute name and consequently the database is configured specifically for each document type that must be stored.

Microsoft has also made available mechanisms for querying relational data in its Microsoft SQL Server product:

(http://msdn.microsoft.com/library/default.asp?url=/library/en-us/dnexxml/html/xml0 7162001.asp) and returning XML.

Three approaches are described, namely RAW, AUTO and EXPLICIT. They all require use of a proprietary extension to an SQL query and are either very limited (RAW, AUTO) or are difficult to program. In the case of RAW, rows are mapped to a fixed and flat document structure, which is almost certainly different to the original document structure. It also can contain some duplicate information. In AUTO mode, the query results can be returned in a nested structure. Table columns are turned into elements or attributes depending on the setting of a flag. In EXPLICIT mode, the XML structure must be specified completely by the developer, and all nesting must be specified as part of the query. This makes the queries complex to program. However these approaches don't specify how to store an original XML document in the database, but describe how relational query results should be transformed into XML.

Other similar approaches have been taken at the West University of Timisoara, Romania where multiple mappings are described in “A mapping between XML and relational databases”, Buga Kornelija, West University of Timisoara, Romania, 2001. The solutions required embedding SQL queries in an XML template, converting table data into a standard structure or required conversion of XML DTDs (Document Type Definition) into a database schema suitable for storing the document. Again this requires database configuration based on the type of documents (i.e. the DTD or schema to which a document conforms) being stored. This paper concludes that provided the XML document is simple, such a mapping might work, but recognises significant shortcomings in a mapping approach for complex documents.

The white paper “XML Persistence” (http://www.xmleverywhere.com/WhitePapers/persistence.htm) reviews the present approaches to XML integration with relational databases and concludes that it is essential to design a database schema for each XML document and that the use of relational database extensions for storing XML in such a database is not yet viable.

According to a first aspect of the invention therefore, there is provided a method of storing a hierarchical document in a relational database comprising parsing a hierarchical document, associating a unique identifier with respective parsed nodes of the document which includes information about the hierarchical position of the node in the document, storing the node with its identifier in a table of a relational database.

Advantageously, the identifiers are associated such that a predetermined ordering of the identifiers and associated nodes in the database produces a predetermined ordering of nodes. Preferably, this predetermined ordering of the nodes is that produced by a depth first traversal of a tree representation of the hierarchical document.

Advantageously, the identifier includes a separate character position for each hierarchical level in the document which is traversed to reach the associated node in the hierarchical document. Preferably, a unique prefix character is used each time the number of nodes in a particular hierarchical level exceeds the unique characters in the identifier alphabet.

Advantageously, at least one database table entry includes a document identifier which identifies the hierarchical document from which an node has been parsed. It is also advantageous that at least one database table entry includes a value field which records a value of the node in the table entry, and that at least one database table entry includes a type field which indicates a characteristic type of the node in the table entry from a predetermined set of types.

In preferred embodiments the hierarchical document is an XML document. Advantageously, at least one database table entry includes a type field which indicates a characteristic type of the node in the table entry from a predetermined set of types and wherein the set of types includes text node, element node, attribute node and/or processing instruction. It is also advantageous that the database table includes YPath and ZPath indexes pointing to predetermined respective entries in respective node and ZPath database tables.

For XML documents, the parsing may for example be carried out using a SAX parser and by writing a specialised handler for the SAX events generated by the parser, which carries out the identifier-associating step. By storing the XML nodes in a relational database with such an identifier, and by choosing the identifier so that a predetermined ordering at the identifiers produces a predetermined ordering of the nodes; for example a lexicographical ordering of the identifiers produces a dynastic ordering of the XML nodes, a very simple single database schema can be used for all XML documents. In an XML document Node refers to distinct parts of an XML document (see http://www.w3c.org). Elements, attributes, text are all examples of nodes.

By including a document identifier, the relational database may also store a plurality of XML documents and may be used to query across that plurality.

In order to support queries using the XPath language an enhancement is suggested. (XPath is derived from “XML Path Language” as defined in W3C recommendation version 1.0 of 16 November 1999). To do this, we introduce the term NodePath, which is simply a specialised XPath expression of the form A[m]/B[n]/C[o]/D[p]/ . . . , where A-D are element names and m-p are integer indexes. The NodePath refers to a unique element node in the XML document. The NodePath can be split into two parts A/B/C/D and mimloip, referred to as the YPath and the ZPath respectively.

By generating second and third tables to store YPath and ZPath values for the different elements in the XML document and cross-referencing these to particular elements in a separate table as parsed by the SAX parser, general XPath queries can be made more easily without having to extract the XML document from the relational database. This allows the benefits of both XML specific query tools and relational database query tools to be combined. The YPath and ZPath tables contain a mapping from an integer identifier to the Y- and ZPaths. The document identifier in which they occur is also be added although it could in principle be dropped; without the document identifier it is possible for the node and node mappings to be used across multiple documents thus economising on storage.

In accordance with a second aspect, the invention provides a relational database comprising a table having an node field for storing an node of a hierarchical document, and an identifier field for storing an identifier associated with each respective node stored in the node field.

In a further method aspect, the invention provides a method of writing a hierarchical document comprising reading data from a relational database which is representative of nodes of a hierarchical document, generating predetermined software events for respective read nodes, and passing the software events to a ContentHandler which is arranged to translate each software event into a written node of the hierarchical document.

In another aspect, the invention provides a computer readable medium carrying a program which when executed on a computer causes storing of a hierarchical document in a relational database by parsing a hierarchical document, associating a unique identifier with respective parsed nodes of the document which includes information about the hierarchical position of the node in the document, storing the node with its identifier in a table of a relational database.

In a further aspect, the invention provides a computer readable medium carrying a program which when executed on a computer causes storing of a hierarchical document in a relational database by receiving software events representing respective parsed nodes of a hierarchical document, associating a unique identifier with the respective parsed nodes of the document which includes information about the hierarchical position of the node in the document, storing the node with its identifier in a table of a relational database.

In another aspect, the invention may provide a computer readable medium carrying a program which when executed on a computer causing writing of a hierarchical document by reading data from a relational database which is representative of nodes of a hierarchical document, generating predetermined software events for respective read nodes, and passing the software events to a ContentHandler which is arranged to translate each software event into a written node of the hierarchical document.

Embodiments of the invention will now be described by way of example with reference to the drawing which is a schematic block diagram showing the interaction between an XML document, a SAX parser and an equivalent tabular representation of the document stored in a relational database.

As noted above, the storage of an XML document in a relational database is difficult primarily because XML documents are tree structures whereas relational databases provide the ability to store data a plurality of cross-referenced tables. This means that tree structures do not readily fit into the relational database construct.

As discussed above, the prior art methods generally require a different database schema to be defined for every different XML document type and furthermore the methods require multiple nested queries from database tables in order to drill down into the hierarchy of the XML document tree.

Accordingly, and with reference to the drawing, an XML document tree 2 is parsed using a software component implementing the XMLReader interface 4. SAX events 6 are passed to a specialised XML database handler 8.

A function of the XML database handler will now be described in detail below. The SAX parser and XML reader 4 traverses the XML document tree 2 in a depth first order. Thus the SAX events are generated in that order and the XML database handler 8 takes these events and processes them by applying a “document ID”, an “node ID” which provides information about the position of the node within the XML tree, a “type” which in the preferred embodiment is selected from one of four types (text node=1, element node=2, attribute node=3, and processing instruction=4), a “name” which is the XML node name and a “value” which is the value of those node types having values. In a further preferred embodiment as discussed in detail below, an additional entry in the primary table is provided to facilitate X path queries on the XML document directly as stored in the relational database.

The selection of an node ID for each node is important. In this invention, the node IDs are chosen so that a lexicographical sort on the node ID will sort the XML nodes into their original depth first traversal. Furthermore, each additional depth in the tree receives an additional character spacing in the node ID.

The starting point for the algorithm to generate node IDs is a combination of the ideas of section heading notation as used in a technical document and Huffman coding. For example subsections in a report can be labelled 1.1.2, 1.1.3, 1.2.1 etc. Provided the maximum integer used in any subsection is less than 10, a lexicographical sort will return the sections in the correct order. However, if this technique were used alone, no particular depth of the XML tree could have more than nine nodes because the tenth node would then contain 1 which would cause the sort to be wrong because 10 comes before 2 in a lexicographical sort.

Therefore, a technique similar to Huffman coding is applied by reserving a character out of a chosen alphabet, to be reserved as a prefix. This guarantees that when the nodes are sorted lexicographically they will be correctly ordered.

With reference to Table 1 below,

TABLE 1
Mapping of Integer Ordinals to Unique Labels for alphabet 0..9

| Ordinal (Integer) | Ordinal Label |
|---|---|
| 0 | 0 |
| 1 | 1 |
| 2 | 2 |
| 3 | 3 |
| 4 | 4 |
| 5 | 5 |
| 6 | 6 |
| 7 | 7 |
| 8 | 8 |
| 9 | 90 |
| 10 | 91 |
| 11 | 92 |
| 12 | 93 |
| 13 | 94 |
| 14 | 95 |
| 15 | 96 |
| 16 | 97 |
| 17 | 98 |
| 18 | 990 |
| 19 | 991 |
| 20 | 992 |
| 21 | 993 |
| 22 | 994 |
| 23 | 995 |
| 24 | 996 |
| 25 | 997 |
| 26 | 998 |
| 27 | 9990 |
| 28 | 9991 |
| 29 | 9992 |

choosing 0.9 as the alphabet and choosing 9 as the reserved prefix character the mapping from the integers 0-29 to ordinal labels can be shown. As will be seen, 10 each time the ordinal reaches a multiple of 9, the prefix character is inserted and the additional label reverts to zero and counts up from there. More generally, the labelling system may be defined as shown in Table 2 where N is the alphabet size and the characters are indexed by their position in a lexicographical ordering of the alphabet. The N^{th} character is reserved as the prefix character.

TABLE 2
Example calculation of the prefix length and final character
of an ordinal label based on the ordinals integer value.

| Ordinal | | Formula for calculating | Formula for calculating |
|---|---|---|---|
| (k) | Label | the index of the final | the Prefix Length of the |
| (integer) | (string) | character of the label | ordinal label |
| 0 | 0 | k mod (N − 1) = 0 | k div (N − 1) = 0 |
| 1 | 1 | = 1 | = 0 |
| 2 | 2 | = 2 | = 0 |
| 9 | 90 | = 0 | = 1 |
| 10 | 91 | = 1 | = 1 |
| 11 | 92 | = 2 | = 1 |
| 18 | 990 | = 0 | = 2 |
| 19 | 991 | = 1 | = 2 |
| 20 | 992 | = 2 | = 2 |

Thus using this labelling scheme, a lexicographical sort of the labels will always result in correct ordering.

As a further enhancement, the length of the labels may be reduced by increasing the alphabet size so that less use of the prefix character is required. For example most of the full ASCII character set could be used providing a range of 254 entries before the prefix character is required. Note that some characters e.g. apostrophe, should not be included as they have a particular meaning to the database. This is a practical consideration.

Now, we turn to the division between different depths of the tree. In the section heading example above, the “.” character is used to indicate subsections. For a node label in the XML tree, a separator character could be reserved to denote the start of a new child ordinal and could be chosen such that it comes before (in the lexicographic ordering sense) the alphabet or ordinal characters. In this way the number of separator characters in the node label specifies the depth of the node within the document tree. The use of separator characters allows easy identification of the different levels within the tree.

However, it will be recognised that the use of a separator character is not essential. This is because, for example, 158912 can only mean 1.5.8.91.2 because of the reserved nature of the prefix character. This is because the presence of a prefix character means that the next non-prefix character is the last part of the current ordinal value.

By removing the separator character, the label length becomes much shorter. In this particular example, it will be noted that the labels could be represented as decimal fractions i.e. the label 1.1.91 could have its separators removed and be represented as the decimal fraction 0.1191. Similarly, 1.2.3 would become 0.123. Arranging the node IDs to be formed as decimal fractions in this way allows a numerical sort to be carried out on the decimal fractions to order the nodes correctly.

As noted above, the use of the digits 0 to 8 and the reservation of the character 9 as a prefix character is somewhat limiting for a typical XML document. Therefore in the example below, the alphabet of characters available to specify the ordinal labels starts with the character “(” (ASCII value=40) and ends with the ASCII character of value of 255.

Furthermore, it will be noted that in an XML document, attribute nodes belong to element nodes and therefore would have the same node label. Thus in order to differentiate these nodes from the element nodes to which they belong, the relational database table includes a node type indicator. This can for example just be an integer. Because an XML file can contain processing instructions before the document root element, in addition, to the XML header <?xml version=“1.0”?>, the root element is labelled as the second child node and the XML header is defined as the first node child of a virtual tree. Other processing instructions are then treated as child nodes of the virtual tree's root. In this embodiment, the node types are defined as text node=1, element node=2, attribute node=3 and processing instruction=4. Note that the example XML documents shown in this invention contain new line characters and tab indents in order to aid readability. However these characters, referred to as white space characters are generally not part of the document. The handling of white space is not standardized although a process of normalization i.e. reducing all sequences of white space characters to a single white space is well known. In this embodiment all white space surrounding an element which is not merely embedded in the flow of text inside another element should be removed first, then all line-end codes within an element should be replaced by spaces and finally all sequences of white space should be reduced to a single space. Similarly all line-end codes preceding a comment or contained within a comment should be removed and sequences of white space replaced with a single white space character.

Thus referring to the following simple XML document (example.xml),

<?xml version=“1.0”>
<rootElement>

<childElement att=“infant”>

John

</childElement>

</rootElement>

the primary database table would be as follows,

TABLE 3
Entries in the primary table for the XML
document example.xml

| DocumentID | NodeID | Type | Name | Value |
|---|---|---|---|---|
| example.xml | ( | 4 | xml | version = “1.0” |
| example.xml | ) | 2 | rootElement | |
| example.xml | ) [symbol] ( | 2 | childElement | |
| example.xml | ) [symbol] ( | 3 | att | infant |
| example.xml | ) [symbol] ( [symbol] ( | 1 | | John |

It will be noted that the character printed as i is representative of the separator character. However, as noted above the separator character is optional.

Thus, for example using the numerical example above having 9 as the reserved character and representing the node IDs as decimal fractions, the following equivalent table (to Table 3) is shown in Table 4.

TABLE 4

| DocumentID | NodeID | Type | Name | Value |
|---|---|---|---|---|
| example.xml | 0.1 | 4 | xml | version = “1.0” |
| example.xml | 0.2 | 2 | rootElement | |
| example.xml | 0.21 | 2 | childElement | |
| example.xml | 0.21 | 3 | att | infant |
| example.xml | 0.211 | 1 | | John |

The node ID model and creation as described above can be expanded to an unlimited number of nodes and levels of the document tree and is thus readily scaleable. No particular database schema are required and any XML document can be represented in this fashion in the relational database. Particular nodes in the document may be amended within the relational database simply by amending a row in the table and without needing to re-index the whole table.

As indicated in the drawing, after operation of the XML database handler 8 a node is stored with its identifier in a table of the relational database. Each node is written as a row in the database. For efficient implementation, these operations may be batched up for commitment to the database on completion of document parsing.

With reference again to the drawing, it will be noted that using a specialised database reader 10, the XML document tree may be recreated using a standard SAX content handler 12 simply by reading the database in order and generating the relevant SAX events. Thus, the technique described above allows an XML document to be easily stored in a relational database, to be modified on an node by node basis without requiring re-indexing, to be queried by standard relational database queries, to have multiple documents stored in the database and to be selectively written out into a standard XML document.

As noted generally above, to support XPath queries, the primary table (as exemplified by Table 3) may be expanded to include additional entries referencing other database tables for YPaths and ZPaths (as shown in Tables 5 and 6).

TABLE 5
YPaths Table

| Document ID | Ref | YPath |
|---|---|---|
| example.xml | 1 | rootElement |
| example.xml | 2 | rootElement/childElement |

TABLE 6
ZPaths Table

| Document ID | Ref | ZPath |
|---|---|---|
| example.xml | 1 | 1 |
| example.xml | 2 | 1/1 |

The expanded primary table (Table 3) is shown below as Table 3a

TABLE 3a
Augmented Document Table using YPath and ZPath identifiers

| | Node | | | | | |
|---|---|---|---|---|---|---|
| DocumentID | ID | Type | Name | Value | YPath | ZPath |
| example.xml | ( | 4 | xml | version = | | |
| | | | | “1.0” | | |
| example.xml | ) | 2 | rootElement | | 1 | 1 |
| example.xml | ) [symbol] ( | 2 | childElement | | 2 | 2 |
| example.xml | ) [symbol] ( | 3 | att | infant | 2 | 2 |
| example.xml | ) [symbol] ( [symbol] ( | 1 | | John | 2 | 2 |

The additional columns of information have been termed YPath and ZPath. The YPath/ZPath column contains an integer identifier (used as a primary key) to lookup the YPath/ZPath for the element contained in the YPath/ZPath table. Note for non-element nodes the YPath/ZPath values point to the paths of the element in which they are contained.

To give an example, of how an XPath query may be performed on a document stored in the relational database. Suppose the database is used to store XML purchase orders which are structured in the following way:

<todaysBusiness>

. . .
<orderid =“po-456”>

<partNum>123</partNum>
<unitPrice units =“GBP”>10</unitPrice>
<quantity>2</quantity>
<shippingAddress>

<name>Joe Smith</name>
<street>Filton road</street>
<city>Bristol</city>
<postcode>AB12 3CD</postcode>

</shippingAddress>

</order>
. . .

<todaysBusiness>

Suppose an employee needs to find the name of the person who issued purchase order po-456. The XPath expression would be todaysBusiness/order[@id=“po-456”]/shippingAddress/name. Suppose the document identifier is biz-xx-yy-zz. One approach to performing this query would be to first identify the ypath and zpath of the attribute containing the entry po-456 in the value column.

SELECT YPath, ZPath FROM primaryTable WHERE value=‘po-456’ AND name=’id’ AND DocumentId=‘biz-xx-yy-zz’;

Supposing Y and Z are the YPath and ZPaths respectively returned from the query. Then the query to find the purchasers name is simply

SELECT value FROM primaryTable WHERE YPath=‘Y/shippingAddress/name’ AND ZPath=‘Z/1/1’ AND DocumentId=‘biz-xx-yy-zz’ AND type=1

This technique supports queries across multiple documents and allows XPath queries to be made directly into the XML document while it is in the relational database rather than needing to be read out into its XML document tree form first.

1. A method of storing a hierarchical document in a relational database comprising
(a) parsing a hierarchical document,
(b) associating a unique identifier with respective parsed nodes of the document which includes information about the hierarchical position of the node in the document,
(c) storing the node with its identifier in a table of a relational database.

2. A method according to claim 1, wherein the identifiers are associated such that a predetermined ordering of the identifiers and associated nodes in the database produces a predetermined ordering of nodes.

3. A method according to claim 2, wherein the predetermined ordering of the nodes is that produced by a depth first traversal of a tree representation of the hierarchical document.

4. A method according to any preceding claim, wherein the identifier includes a separate character position for each hierarchical level in the document which is traversed to reach the associated node in the hierarchical document.

5. A method according to claim 4, wherein a unique prefix character is used each time the number of nodes in a particular hierarchical level exceeds the unique characters in the identifier alphabet.

6. A method according to any preceding claim, wherein at least one database table entry includes a document identifier which identifies the hierarchical document from which an node has been parsed.

7. A method according to any preceding claim wherein at least one database table entry includes a value field which records a value of the node in the table entry.

8. A method according to any preceding claim wherein at least one database table entry includes a type field which indicates a characteristic type of the node in the table entry from a predetermined set of types.

9. A method according to any preceding claim, wherein the hierarchical document is an XML document.

10. A method according to claim 9, wherein at least one database table entry includes a type field which indicates a characteristic type of the node in the table entry from a predetermined set of types and wherein the set of types includes text node, element node, attribute node and/or processing instruction.

11. A method according to claim 9 or claim 10, wherein the database table includes YPath and ZPath indexes pointing to predetermined respective entries in respective node and ZPath database tables.

12. A relational database comprising a table having an node field for storing an node of a hierarchical document, and an identifier field for storing an identifier associated with each respective node stored in the node field.

13. A database according to claim 12, wherein at least one database table entry includes a document identifier field for storing a document identifier which identifies the hierarchical document from which an node has been parsed.

14. A database according to claim 12 or claim 13, wherein at least one database table entry includes a value field for recording a value of an node in the respective table entry.

15. A database according to any of claims 12 to 14, wherein at least one database table entry includes a type field for storing an indication of a characteristic type of an node in the respective table entry from a predetermined set of types.

16. A database according to any of claims 12 to 15, wherein the database table includes node and ZPath indexes referencing respective entries in respective node and ZPath database tables in the database.

17. A database according to claim 16 wherein the YPath table includes fields for storing XPath element names and document IDs.

18. A database according to claim 16 or claim 17, wherein the ZPath table includes fields for storing XPath integer indexes and document IDs.

19. A method of writing a hierarchical document comprising:—
(a) reading data from a relational database which is representative of nodes of a hierarchical document,
(b) generating predetermined software events for respective read nodes, and
(c) passing the software events to a content handler which is arranged to translate each software event into a written node of the hierarchical document.

20. A computer readable medium carrying a program which when executed on a computer causes storing of a hierarchical document in a relational database by:—
(a) parsing a hierarchical document,
(b) associating a unique identifier with respective parsed nodes of the document which includes information about the hierarchical position of the node in the document,
(c) storing the node with its identifier in a table of a relational database.

21. A computer readable medium carrying a program which when executed on a computer causes storing of a hierarchical document in a relational database by:—
(a) receiving software events representing respective parsed nodes of a hierarchical document,
(b) associating a unique identifier with the respective parsed nodes of the document which includes information about the hierarchical position of the node in the document,
(c) storing the node with its identifier in a table of a relational database.

22. A computer readable medium carrying a program which when executed on a computer causing writing of a hierarchical document by:—
(a) reading data from a relational database which is representative of nodes of a hierarchical document,
(b) generating predetermined software events for respective read nodes, and
(c) passing the software events to a content handler which is arranged to translate each software event into a written node of the hierarchical document.
